(19) United States
(12) Patent Application Publication
(10) Pub. No.: US 2005/0101429 A1
(43) Pub. Date: May 12, 2005

(54) Transfer case having high-range and low-range selection controlled through a coupler

(76) Inventors: Timothy Allen, Livonia, MI (US); Steven Thomas, Bloomfield Hills, MI (US); Matthew Hammond, Redford, MI (US); Donald Hoffman, Canton, MI (US)

Correspondence Address: Donald Wilkinson;MacMillan Sobanski & Todd, Suite 405, 38705 W. Seven Mile Road, Livonia, MI, 48152, US

(21) Appl. No.: 10/706,215

(22) Filed: Nov. 12, 2003

(51) Int. Cl. F16H 48/20

(52) U.S. Cl. 475/223

(57) ABSTRACT

In a driveline for a motor vehicle, an automatic transmission having an output shaft connected to a transfer case input, a planetary gearset, a coupler having positional states that alternatively produce a high speed range and low speed range, a friction clutch that alternatively driveably connects the output and a forward drive shaft, or releases the connection between the output and forward drive shaft, without regard to the positional state of the coupler or speed range produced by the transfer case.

### BACKGROUND OF THE INVENTION

1. Field of the Invention

This invention relates to a driveline for a motor vehicle, in particular to a driveline having a transfer case for directing power to front wheels and rear wheels.

2. Description of the Prior Art

A transfer case usually includes a planetary gear set for producing either a “high” range, in which the transfer case output is driven at the same speed as the input, or a “low” range, in which the output is driven slower than its input speed. The 4×2 and 4×4 states of the transfer case are usually selected manually by the vehicle operator by operating a lever or switch. A first position of the lever will cause a range selection device in the transfer case to direct power from the transmission output to a rear drive axle, the 4×2 drive mode. A second position of the lever will cause the transfer case to direct power to both a front drive axle and a rear drive axle, the 4×4 drive mode.

Conventionally the high and low ranges are produced by alternately engaging and disengaging a hydraulically actuated range clutch. When the 4×4 drive mode is selected, another hydraulic clutch is engaged. The hydraulic clutches that control high and low range operation typically include a clutch pack of alternating spacer plates and friction discs, which are forced into friction contact when a piston located in a cylinder is pressurized with hydraulic fluid, thereby engaging the clutch. The clutch is disengaged by venting the cylinder, which allows a spring to release the piston allowing the plates and discs to separate.

However, even when the discs and plates are disengaged, they are located in close mutual proximity so that the clutch can be quickly reengaged without loss of time required to first move the plates and discs together from a widely separated distance when the operator commands a range change. With the plates and discs closely spaced and the clutch disengaged, hydraulic fluid is continually supplied to the clutch pack in order to cool and lubricate the clutch. In this environment, hydraulic fluid between the discs and plates causes the clutch components to rotate due to viscous shear through the thickness of fluid between the plates and discs, even when the clutch is disengaged.

This action produces a continual drag on the powertrain components, increasing fuel consumption and adding to noise and noise amplification in the driveline. It is better to avoid these disadvantages and yet quickly respond to commands to change the selected range.

The multiplate hydraulic clutch that is engaged when the low range is produced transmits torque that is amplified through operation of a gearset located in the transfer case between the transmission output shaft and the transfer case output. In order to transmit large torque magnitudes, potentially as large as the vehicle skid torque at which the wheels break free from frictional contact with a road surface, the size of the low range clutch is large. Its size presents packaging difficulties in the transfer case where two other clutches, an epicyclic train and a drive mechanism to the front wheels are also located. A solution is required to avoid the packaging difficulties presented by the size of a hydraulically-actuated low range clutch.

### SUMMARY OF THE INVENTION

It is an advantage of this invention that the driveline drag and fuel efficiency reduction associated with viscous shear continually present in a transfer case having at least one disengaged, hydraulic actuated range clutch is eliminated.

It is another advantage that unnecessary noise caused by continual rotation of the transfer case and driveline components unintentionally driven by a disengaged hydraulic clutch is eliminated.

It is yet another advantage that the space normally required to package a low range clutch and high range clutch in a transfer case is avoided. This invention also eliminates the design, manufacturing, and assembly complexity and cost required to supply these clutches with hydraulic fluid and the control system features that synchronize their engagements and disengagements.

In realizing these advantages, a power transfer mechanism according to this invention for connecting and disconnecting multiple outputs, includes an input; a first output; a second output; an epicyclic train that includes a first component driveably connected to the input, a second component driveably connected to the first output, and a third component; a coupler driveably connected to the third component; including a selector moveable alternately between a first position where the coupler completes a drive connection that holds the third component against rotation, and a second position where the coupler mutually driveably connects the third component and first output; and a clutch for alternately mutually connecting and releasing the first output and second output.

### BRIEF DESCRIPTION OF THE DRAWINGS

FIG. 1 is a top view of a motor vehicle driveline having a transmission, transfer case, and drive shafts extending to front wheels and rear wheels.

FIGS. 2A and 2B are left-hand and right-hand portions, respectively, of a cross sectional side view showing an integrated transfer case and a portion of an automatic transmission.

FIG. 3 is cross sectional side view in the vicinity of a synchronizer coupler.

FIG. 4 is a partial cross section of a coupler showing a blocker ring and disc.

FIG. 5 is a schematic diagram of an alternate arrangement in which a coupler is located in a torque delivery path between the transmission output and a gearset.

FIG. 6 is a schematic diagram of the arrangement shown in FIG. 2.

### DESCRIPTION OF THE PREFERRED EMBODIMENT

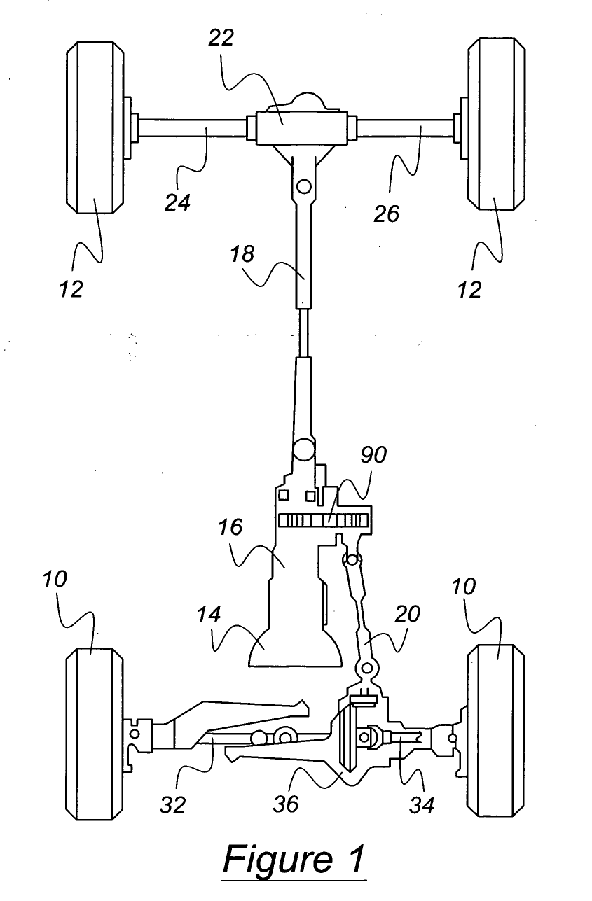

With reference now to the drawings and particularly to FIG. 1, the powertrain of a motor vehicle, to which the present invention can be applied, includes front and rear wheels 10, 12, a power transmission 14 for producing multiple forward and reverse speed ratios driven by an engine (not shown), and a transfer case 16 for continuously driveably connecting the transmission output to a rear drive shaft 18. The transfer case 16 selectively connects the transmission output to both the front drive shaft 20 and rear drive shaft 18 when a four wheel drive mode of operation is selected, either manually or electronically. Shaft 18 transmits power to a rear wheel differential mechanism 22, from which power is transmitted differentially to the rear wheels 12 through axle shafts 24, 26, which are contained within a differential housing. The~front wheelbase driveably connected to right-hand and left-hand axle shafts 32, 34, to which power is transmitted from the front drive shaft 20 through a front differential mechanism 36.

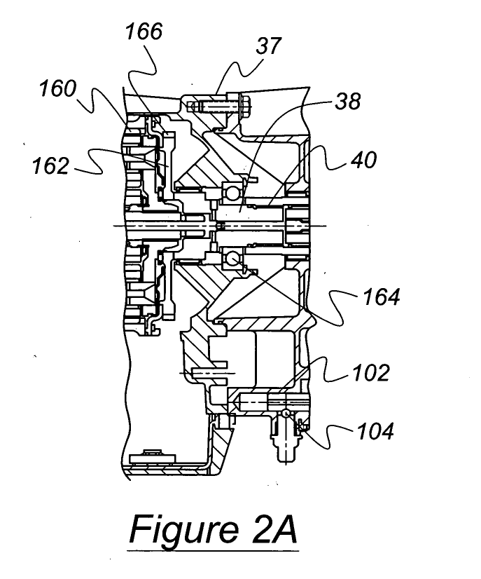

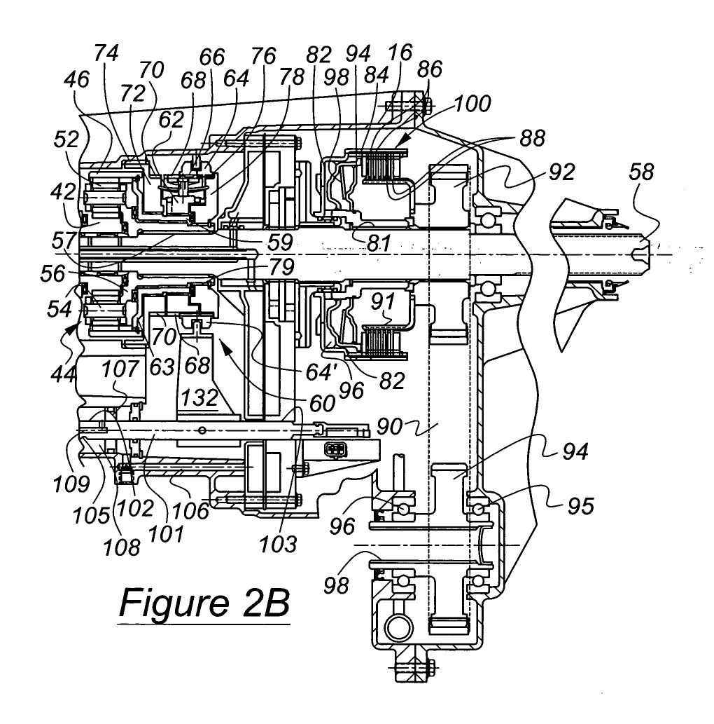

Referring now to FIGS. 2A and 2B, the output shaft 38 of the automatic transmission,14 extends through the transmission casing 37 into the casing 16 of the transfer case. Shaft 38 is driveably connected through a spline 40 to the sun gear 42 of a simple planetary gear set, an epicyclic train 44. Sun gear 42 is in continuous meshing engagement with a set of planet pinions 52, which are supported for a rotation on stub shafts 54, each stub shaft supported at opposite axial ends on a carrier 56. Each of the planet pinions 52 is in continuous meshing engagement with the sun gear 42 and a ring gear 46. Carrier 56 is driveably connected through spline 57 to the output 58 of the transfer case, which is adapted for connection to the rear driveshaft 18.

A high-low coupler 60 includes a hub 62, which is driveably connected through a spline 59 and radial disc 63 to ring gear 46. Coupler 60 includes a sleeve 64, formed on its inside surface with a system of axially directed spline teeth 66, engaged continuously with a system of spline teeth 68 formed on the outer surface of the hub 62. The sleeve 64 slides axially leftward and rightward on the hub. In FIG. 2, the coupler 60 shown above the axis of output shaft 58 is a synchronizer; the coupler shown below that axis is a dog clutch.

The teeth 66 of the sleeve 64 are engageable alternately with axially directed spline teeth 70 formed on a radially outer surface of a disc 72, which is continually fixed against a rotation by its engagement at 74 with teeth formed on the inner surface of the transfer case 16. The teeth 66 of sleeve 64 are engageable also with a system of axially directed spline teeth 76 formed on a radially outer surface of a disc 78.

Disc 78 is splined at 79 to carrier 56, which is splined at 57 to output shaft 58. Spline 81 driveably connects shaft 58 to a drum 82; which is formed on its inner surface with axially directed spline teeth 84. Spacer plates 86 are driveably engaged with the spline 84 of drum 82. Friction discs 88, interposed between adjacent spacer plates 86, are driveably engaged by spline teeth formed on the outer surface of an arm 91, which extends axially from a drive belt sprocket wheel 92.

Located within drum 82 is a hydraulically actuated piston 94, which moves axially in response to the pressurized and vented state of a hydraulic cylinder 96 located between drum 82 and piston 94. When cylinder. 96 is pressurized, piston 94 moves rightward forcing the spacer plates 86 and friction discs 88 into mutual frictional engagement, thereby driveably connecting output 58 and sprocket wheel 92. When cylinder 96 is vented, piston 94 is moved leftward to the position shown in FIG. 2 due to a force applied to the piston by a Belleville spring 98, thereby driveably disconnecting output 58 and sprocket wheel 92. In this way, clutch 100 alternately driveably connects and disconnects output 58 and sprocket wheel 92.

When clutch 100 is engaged, power is transmitted to the forward drive shaft 20 from the output shaft 58 by a drive belt 90, which is continually engaged with sprocket wheel 92. Bearings 95, 96 rotatably support sprocket wheel 94 on the transfer case 16, and forward drive shaft 20 is driveably connected through a spline 98 formed on the inner surface of the sprocket wheel 94. In this way, when clutch 100 is engaged, output shaft 80 transmits power both to the rear drive shaft 18, which is connected by a universal joint to output shaft 80, and to the forward drive shaft 20.

In operation, drive shaft 20 is driven alternately at the same speed as that of the transmission output shaft 38, or shaft 20 is underdriven in relation to the speed of shaft 38, in accordance with the position of the coupler sleeve 64.

Carrier 56 is continually driveably connected to output shaft 58 through spline 57. Ring gear 46 is driveably connected to output shaft 58 through the torque delivery path that includes disc 63, coupler hub 62, coupler sleeve 64, disc 78 and splines 79, 57. Therefore, when sleeve 64 moves rightward to the position shown in FIG. 2, ring gear 46 and carrier 56 are mutually driveably connected, and ring gear 46, carrier 56 and output 58 are driven at the same speed as that of sun gear 42 and the input 38. This is the high-speed range.

When sleeve 64 of coupler 60 is moved leftward to produce a drive connection between disc 72 and coupler hub 62, ring gear 46 is fixed against rotation on the transfer case 16 through the torque path that includes disc 63, coupler hub 62, its sleeve 64 and disc 72. This provides a torque reaction and causes carrier 56 and output 58 to be underdriven in relation to the speed of sun gear 42 and shaft 38. This creates a low-range drive connection between transmission output 38 and the transfer case output 58.

Clutch 100 can be engaged regardless of the position of coupler sleeve 64 so that power is transmitted by the drive belt mechanism, which includes sprocket wheels 92, 94 and drive belt 90. In this way, both the forward drive shaft 20 and rear drive shaft 18 are driven alternately in the low-range and high-range, or only the rear drive shaft is driven in the low-range and high-range.

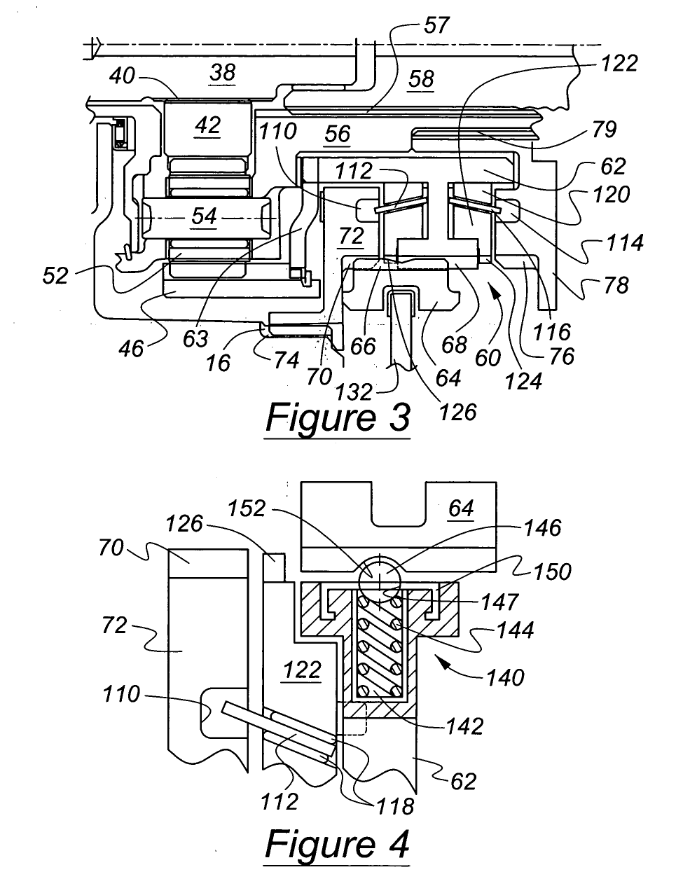

Referring now to FIGS. 3 and 4, the coupler 60 is preferably a synchronizer of the type used in manual automotive transmissions to connect and release rotating components after first synchronizing their rotational speeds. Disc 72 is formed with a pocket 110, in which a friction cone 112 is supported for rotation with disc 72. Similarly disc 78 is formed with a pocket 114, in which a friction cone 116 is supported for rotation with disc 78. Each friction cone 112, 116 carries friction material bonded to its upper and lower surfaces.

Located at each lateral side of the hub 62 is a radially inner blocker ring 120, which is supported on the hub for sliding movement in opposite axial directions toward the discs 72, 78. Located at each lateral side of the hub 62 and radially outward from the inner blocker ring 120 is outer blocker ring 122, which is supported on cones 112, 116 for sliding movement in opposite axial directions toward the discs 72, 78. Blocker ring 122 carries sets of dog teeth 124, 126, each set located on an opposite side of the hub 62. The sleeve 64 has spline teeth 66 continually engaged with outer spline teeth 68 formed on the radially outer end of the hub, and alternately engageable with teeth 124, 126 on blocker ring 122, depending on the axial location of the sleeve 64.

The operator places the transmission in the 4×4 and 4×2 drive modes by moving a selector lever. A shift fork 132, fitted in a recess on the sleeve 64, is actuated to move leftward or rightward, preferably by a hydraulic piston or a solenoid, in response to a command produced manually by the vehicle operator. The manual input may result upon depressing a range selector button located in the passenger compartment. When sleeve 64 moves leftward to the position of FIG. 3, ring gear 46 is grounded against rotation on the transfer case, and the low range is produced. When sleeve 64 moves rightward, carrier 56 is connected to the ring gear 46 through the output shaft 58 and splines 57, 79 and the high range is produced. The speed of hub 62 is synchronized with the speed of discs 72, 78 due to their mutual frictional engagement with the blocker rings and cones 112, 116.

FIG. 2 shows the shift fork 132 fixed to a shift rail 101, which is journalled for lateral displacement at 102, 103 on the case 16. The shift rail moves between detent positions 104, 105, representing the low range and high range respectively. The shift rail moves in response to hydraulic pressure applied and vented alternately to opposite sides of a piston 107 located in a cylinder 108. Pressure applied to piston 107 through passage 109 moves the piston rightward. Pressure applied to piston 107 through passage 106 moves the piston leftward.

FIG. 4 shows a detent assembly 140, one of about four such assemblies spaced mutually angularly on the hub 62 and located in a blank space 142 between successive spline teeth 68 on the hub 62. A helical compression spring 144 biases a ball 146 radially outward through an opening 147 in a clip 150, retained on the hub and in contact with a recess 152 formed on the radially inner surface of sleeve 64.

As the sleeve moves leftward, it pushes the detent assembly 140 leftward against the blocker ring 122, which contacts the friction cone 112. This contact and the associated friction force between blocker ring 122 and cone 112, tend to synchronize the speeds of the hub 62 and disc 72. When those speeds are sufficiently synchronized, sleeve 64 moves further leftward into engagement with dogteeth 126 on blocker ring, 122 and dogteeth 70 on disc 72. In this way, synchronizer 60 completes a drive connection between ring gear 46 and case 16, thereby holding the ring gear against rotation and producing the low range, due to disc 72 being continually held against rotation on the case 16.

FIG. 2 shows, below the longitudinal axis of shaft 58, an alternative arrangement in which the coupler is a dog clutch having dogteeth, which are engaged alternately with teeth 70, 76 on discs 72, 78, respectively. Sleeve 64 slides leftward and rightward on hub 62 while remaining engaged with teeth 68 on the outer surface of hub 62.

The transmission output 38 is driven by a ring gear 160, which is secured through a park gear 162 to output shaft 38. The park gear and shaft 38 are supported on the transmission case 37 by a bearing 164. The outer surface of the park gear is formed with teeth 166 separated by spaces adapted for engagement by a park mechanism.

FIG. 5 is a schematic diagram of an alternate arrangement in which a coupler 60′ alternately grounds ring gear 46 and connects sun gear 42 and ring gear 46. The coupler 60′ is located in a torque delivery path between the transmission output 38′ and the epicyclic train 44 that produces the high and low ranges. By locating the coupler 60′ at the left-hand side of gear set 44, the force required to move shift fork 132 and sleeve 64 is reduced for a given input speed compared to the force required to move the fork and sleeve when the coupler 60 is located at the right-hand side of the, gearset, shown in FIGS. 2 and 3.

In the arrangement of FIG. 5, disc 78 is deleted and replaced by disc 134, which is driveably connected to the transmission output 38′. Sun gear 42 is driveably connected to the input 38′; carrier 52 is secured to first output shaft 58′; ring gear 46′ is driveably connected to the hub 62′ of coupler 60′. Disc 72′ is secured against rotation on the case 16′. The output of the gearset is taken at carrier 52.

The low range is produced by moving coupler sleeve 64′ rightward to hold ring gear 46′ against rotation on the case 16′. Moving coupler sleeve 64′ leftward to driveably connect sun gear 42 and ring gear 46′ mutually through the transmission output 38′ locks up the epicyclic train and produces the high range. Friction clutch 100′ alternately connects and releases the second output, represented by sprocket wheel 92, and the first output, shaft 58′.

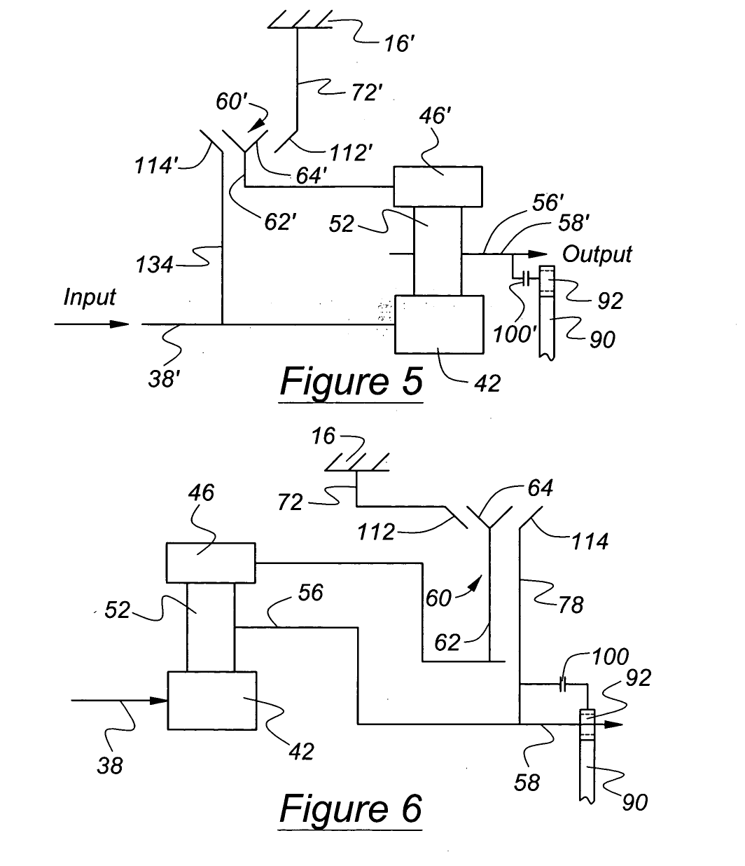

FIG. 6 is a schematic diagram of the arrangement shown in FIG. 2.

Although the form of the invention shown and described here constitutes the preferred embodiment of the invention, it is not intended to illustrate all possible forms of the invention. Words used here are words of description rather than of limitation. Various changes in the form of the invention may be made without departing from the spirit and scope of the invention as disclosed.

1. A transfer mechanism for producing power in speed ranges and for transmitting such power selectively, comprising:
a power input;
a first output;
a second output;
an epicyclic gearset including a first component driveably connected to the input, a second component driveably connected to the first output, and a third component;
a coupler continually driveably connected to the third component, including a selector moveable alternately between a first position where the coupler completes a drive connection that holds the third component against rotation, and a second position where the coupler mutually driveably connects the third component and one of the group consisting of the first component and second component; and
a clutch for alternately mutually connecting and releasing the first output and second output.

2. The transfer mechanism of claim 1, wherein:
the first component is a sun gear driveably connected to the input;
the second component is a carrier driveably connected to the first output;
the third component is a ring gear, driveably connected to the coupler; and
further comprising a set of planet pinions rotatably supporting on the carrier in meshing engagement with the sun gear and ring gear.

3. The transfer mechanism of claim 1; wherein a speed of the first output is less than a corresponding speed of the input when the selector is in the first position, and a speed of the first output is greater than a corresponding speed of the input when the selector is in the second position.

4. The transfer mechanism of claim 1, further comprising:
a first set of wheels adapted for a drive connection to the first output; and
a second set of wheels adapted for drive connection to the second output.

5. The transfer mechanism of claim 2, further comprising:
a transfer case fixed against rotation;
a first disc located adjacent the selector for engagement therewith, and secured to the transfer case;
a second disc located adjacent the selector for engagement therewith, and driveably connected to one of the carrier and sun gear; and
wherein the coupler comprises a hub driveably connected to the ring gear, and supporting the selector thereon for movement alternately into engagement with the first disc and second disc.

6. The transfer mechanism of claim 1, wherein the coupler is a synchronizer.

7. The transfer mechanism of claim 1, wherein the coupler is a member of a group consisting of a synchronizer and dog clutch.

8. The transfer mechanism of claim 1, wherein the second output further comprises:
a drive mechanism including a first sprocket wheel driveably connected to the clutch, a second sprocket wheel spaced from and aligned with the first sprocket wheel, and a drive belt engaged with the first sprocket wheel and second sprocket wheel.

9. The transfer mechanism of claim 1, wherein the clutch further comprises:
a first member driveably connected to the first output;
a second member driveably connected to the second output;
a first set of friction elements engaged with the first member;
a second set of friction elements engaged with the second member, elements of the first set and second set being disposed alternately and arranged for mutual a piston moveable in the frictional engagement;
a cylinder; and cylinder in response to a pressurized state and a vented state of the cylinder, alternately driveably connecting and disconnecting the first set of friction elements and second set of friction elements, whereby the first output and second output are alternately driveably connected and disconnected.

10. A transfer mechanism for producing power in speed ranges and for transmitting such power selectively, comprising:
a transmission casing containing a transmission output;
a transfer case fixed against rotation and secured to the transmission casing;
a first output;
a second output;
a sun gear driveably connected to the transmission output;
a carrier driveably connected to the first output;
a ring gear;
a set of planet pinions rotatably~supporting on the carrier in meshing engagement with the sun gear and ring gear;
a coupler driveably connected to the ring gear, including a selector moveable alternately between a first position where the coupler completes a drive connection between the transfer case and ring gear, and a second position where the coupler mutually driveably connects the ring gear and one of the group consisting of the sun gear and carrier; and
a clutch for alternately mutually connecting and disconnecting the first output and second output.

11. The transfer mechanism of claim 10, wherein a speed of the carrier is less than a corresponding speed of the transmission output when the selector is in the first position, and a speed of the carrier is greater than a corresponding speed of the transmission output when the selector is in the second position.

12. The transfer mechanism of claim 10, further comprising:
a first set of wheels adapted for a drive connection to the first output; and
a second set of wheels adapted for drive connection to the second output.

13. The transfer mechanism of claim 10, further comprising:
a first disc secured to the transfer case against rotation, located adjacent the selector for engagement with the selector; and
a second disc located adjacent the selector for engagement with the selector, and driveably connected to one of the carrier and sun gear; and
wherein the coupler comprises a hub driveably connected to the ring gear and supporting the selector thereon for movement alternately into engagement with the first disc and second disc.

14. The transfer mechanism of claim 10, wherein the coupler is a synchronizer.

15. The transfer mechanism of claim 10, wherein the coupler is a member of a group consisting of a synchronizer and dog clutch.

16. The transfer mechanism of claim 10, wherein the second output further comprises:
a drive mechanism located in the transfer case, including a first sprocket wheel driveably connected to the clutch, a second drive sprocket wheel spaced from and aligned with the first sprocket wheel, and a drive belt driveably engaged with the first sprocket wheel and second sprocket wheel.

17. The transfer mechanism of claim 10, wherein the clutch further comprises:
a first member driveably connected to the first output;
a second member driveably connected to the second output;
a first set of friction elements engaged with the first member;
a second set of friction elements engaged with the second member, elements of the first set and second set being disposed alternately and arranged for mutual frictional engagement;
a cylinder; and
a piston moveable in the cylinder in response to a pressurized state and a vented state of the cylinder, alternately driveably connecting and disconnecting the first set of friction elements and second set of friction elements, whereby the first output and first sprocket wheel are alternately driveably connected and disconnected.

18. A transfer mechanism for producing power in speed ranges and for transmitting such power selectively, comprising:
a transfer case fixed against rotation;
a transmission having an output shaft;
a first output shaft axially aligned with the transmission output shaft;
a second output shaft substantially parallel to the first output shaft;
an epicyclic gearset including a sun gear driveably connected to the transmission output shaft, a carrier driveably connected to the first output shaft, a ring gear, and a set of planet pinions rotatably supporting on the carrier in meshing engagement with the sun gear and ring gear;
a first disc secured to the transfer case against rotation;
a second disc spaced axially along the first output shaft from the first disc, and driveably connected to one of the carrier and sun gear;
a coupler coaxial with the first input shaft, located between the first disc and second disc, including a hub driveably connected to the ring gear, the hub supporting a selector for movement alternately into engagement with the first disc and second disc.

19. The transfer mechanism of claim 18, further comprising:
a drive mechanism including a first sprocket wheel journalled on the first output shaft, a second sprocket wheel secured to the second output shaft and substantially aligned axially with the first sprocket wheel, and a drive belt driveably engaged with the first sprocket wheel and second sprocket wheel; and
a clutch for alternately mutually connecting and disconnecting the first output shaft and first sprocket wheel.

20. The mechanism of claim 18, wherein a speed of the carrier and first output shaft is less than a corresponding speed of the transmission output when the selector is engaged with the first disc, and a speed of the carrier and first output shaft is greater than a corresponding speed of the transmission output when the selector is engaged with the second disc.

21. The transfer mechanism of claim 18, further comprising:
a first set of wheels adapted for a drive connection to the first output shaft; and
a second set of wheels adapted for drive connection to the second output shaft.

22. The transfer mechanism of claim 18, wherein the coupler is a synchronizer.

23. The transfer mechanism of claim 18, wherein the coupler is a member of a group consisting of a synchronizer and dog clutch.

24. The transfer mechanism of claim 19, wherein the clutch further comprises:
a first member driveably connected to the first sprocket wheel;
a second member driveably connected to the first output shaft;
a first set of friction elements engaged with the first sprocket wheel;
a second set of friction elements engaged with the second disc, elements of the first set and second set being disposed alternately and arranged for mutual frictional engagement;
a cylinder;
a piston moveable in the cylinder in response to a pressurized state and a vented state of the cylinder, alternately driveably connecting and disconnecting the first set of friction elements and second set of friction elements, whereby the first output shaft and second output shaft are alternately mutually driveably connected and disconnected.
